(19) United States
(12) Patent Application Publication
(10) Pub. No.: US 2026/0228090 A1
(43) Pub. Date: Aug. 6, 2026

(54) SYSTEM FOR DETECTING DATA CORRUPTION IN BACKUP SYSTEM

(71) Applicant: Druva Inc., Santa Clara, CA (US)

(72) Inventors: Yogendra ACHARYA, Pune (IN); Anand Dinkar APTE, Pune (IN); Hrishikesh PALLOD, Pune (IN); Shubham PENDHARKAR, Pune (IN)

(73) Assignee: Druva Inc., Santa Clara, CA (US)

(21) Appl. No.: 19/529,890

(22) Filed: Feb. 4, 2026

(30) Foreign Application Priority Data
Feb. 5, 2025 (IN) 202541009465

(51) Int. Cl. G06F 11/1446

(52) U.S. Cl. CPC G06F 11/1469

(57) ABSTRACT

The invention provides a system for detecting data corruption in a backup system. The system includes a memory storing one or more processable routines and a processor communicatively coupled to the memory. The processor is configured to execute one or more processor-executable routines to access backup data with a plurality of backup datasets stored in a backup storage system. The backup datasets comprise block-level data snapshots of data files for one or more customers stored on a source. The processor is further configured to identify a subset of the backup data across a plurality of backup cycles using a pseudo-random generator. The processor is further configured to compare checksums of one or more data blocks of the files of the identified subset with checksums of corresponding source data blocks to detect data corruption in the backup system. The processor is further configured to generate or update an integrity check log with the detected data corruption information.

### PRIORITY STATEMENT

The present application claims priority under 35 U.S.C. § 119 to Indian patent application number 202541009465 filed 5 Feb. 2025, the entire contents of which are hereby incorporated herein by reference.

### FIELD OF INVENTION

Embodiments of the present disclosure relate to data management and protection, and more particularly, to techniques for detecting data corruption in backup system.

### BACKGROUND

The increasing reliance on digital data across industries has necessitated robust systems for data backup and recovery. Backup systems are critical for ensuring data availability, especially in the face of accidental deletion, system failures, cyberattacks, or natural disasters.

Current backup solutions often use block-level snapshots to efficiently capture and store data changes, enabling faster backup restore operations and optimized storage utilization. However, ensuring the integrity of these backups is a persistent challenge, particularly in large-scale environments involving massive datasets across local, network-attached, and cloud-based storage systems.

Data corruption can occur at any stage in the backup process, such as during data transfer, storage, or retrieval. Corrupted data may remain undetected for extended periods, particularly when large datasets are involved, making recovery efforts more challenging and resource-intensive. The reliance on checksum verification for data integrity checks provides a proven mechanism, but the volume of data in large-scale environments may render exhaustive checks impractical.

Traditional backup verification techniques often rely on sequential data validation or ad-hoc manual checks, both of which are time-consuming and resource-intensive. Ensuring comprehensive coverage of all data blocks across multiple backup cycles without affecting system performance or operational continuity remains a significant bottleneck. Moreover, systems must be capable of identifying and flagging corrupted data blocks promptly to facilitate timely recovery or manual intervention.

There is a need for a systematic, efficient, and automated mechanism for detecting data corruption in backup systems. It may be helpful to have a solution that can support diverse storage environments while providing actionable insights via detailed integrity logs for timely recovery actions.

### BRIEF DESCRIPTION

The following description is illustrative only and is not intended to be in any way limiting. In addition to the illustrative aspects, example embodiments, and features described, further aspects, example embodiments, and features will become apparent by reference to the drawings and the following detailed description.

Briefly, according to the example embodiments, a system for detecting data corruption in a backup system is provided. The system includes a memory storing one or more processable routines and a processor communicatively coupled to the memory. The processor is configured to execute one or more processor-executable routines to access backup data with a plurality of backup datasets stored in a backup storage system. The backup datasets comprise block-level data snapshots of data files for one or more customers stored on a source. The processor is further configured to identify a subset of the backup data across a plurality of backup cycles using a pseudo-random generator. The processor is further configured to compare checksums of one or more data blocks of the files of the identified subset with checksums of corresponding source data blocks to detect data corruption in the backup system. The processor is further configured to generate or update an integrity check log with the detected data corruption information.

According to another example embodiment, a system for detecting data corruption in a large-scale backup environment is provided. The system includes a memory storing one or more processable routines and a processor communicatively coupled to the memory. The processor is configured to execute one or more processor-executable routines to initiate a backup operation of plurality of backup datasets between a backup storage system and cloud storage. The backup sets comprise block-level data snapshots. The processor is further configured to capture checksums of source data blocks during the backup process. The processor is further configured to identify data block offsets for integrity verification using a predetermined method. The processor is further configured to read the data blocks at the identified offsets from both the source and the backup storage system. The processor is further configured to compare the identified data blocks.

According to another example embodiment, a method for detecting data corruption in a large-scale backup environment is provided. The method includes storing backup data from multiple customer sources in a backup storage system. The backup data comprises block-level data snapshots. The method further includes selecting a subset of data blocks from the backup dataset using a pseudo-random generator. The method further includes comparing the checksum of the selected data blocks between the source data and the corresponding backup. The method further includes generating a report detailing any detected data corruption or integrity failures within the verified data blocks. The method further includes flagging and reporting the corrupted data blocks for further investigation or recovery. The method further includes repeating the process across multiple backup cycles to ensure that all data blocks and files are verified at least once.

### BRIEF DESCRIPTION OF THE DRAWINGS

The disclosure will be described and explained with additional specificity and detail with the accompanying figures in which:

FIG. 1 is a block diagram representation of components of a system for detecting data corruption in a backup storage system, according to some aspects of the present description;

FIGS. 2A & 2B are workflows of detecting data corruption in a backup storage system, according to some aspects of present description.

FIG. 3 is a flow chart of the process of detecting data corruption in a backup storage system.

FIG. 4 is a block diagram of an embodiment of a computing device in which the dynamic data-backup scheduling system, described herein, is implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

This section will describe an illustrative architecture for a detecting data corruption in a backup system.

Embodiments of the invention provide a system for detecting data corruption in backup systems that is designed to seamlessly monitor, identify, and mitigate potential data integrity issues during backup and restoration processes. These embodiments address challenges associated with current backup systems that often rely on manual verification or are unable to detect corruption until data retrieval. The system enhances reliability by incorporating real-time integrity checks, automated error detection mechanisms, and intelligent recovery protocols, offering users a more secure, efficient, and resilient data protection solution.

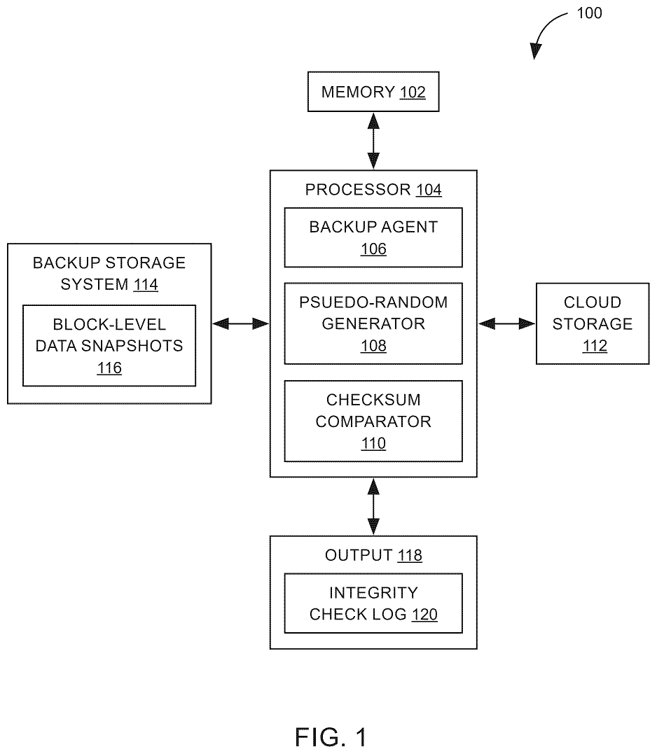

FIG. 1 is a block diagram 100 illustrating components of a system for detecting data corruption in a backup storage system to implement some embodiments of the invention. The system 100 includes a memory 102, a processor 104 and a backup storage system 114. The memory 102 is configured to store one or more processable routines. The processor 104 is communicatively coupled to the memory 102 to execute the one or more processor-executable routines to access, analyze and verify the integrity of backup datasets stored on the backup storage system 114 and a cloud storage 112.

In the illustrated embodiment, the processor 104 includes a backup agent 106, a pseudo-random generator 108, and a checksum comparator 110. In operation, the processor 104 is configured to access backup data that includes plurality of backup data sets stored in the backup storage system 114 via the backup agent 106. The backup datasets include block-level data snapshots generally represented by reference numeral 116 of data files for one or more customers, with the corresponding source data files stored on the cloud storage 112. The block-level data snapshots 116 may enable efficient and precise integrity verification and validate each segment of the backup dataset for consistency and reliability.

The processer 104 is further configured to identify a subset of backup data for verification using the pseudo-random generator 108. The pseudo-random generator 108 is configured to employ pseudo-random techniques to achieve a uniform distribution of selected data blocks/offsets across multiple backup cycles to ensure comprehensive coverage of the backup data. The processor 104 is configured to identify the subset such that each data block/offset of the subset is verified at least once within a predetermined number of backup cycles.

In one embodiment, the pseudo-random generator 108 includes a Linear Congruential Generator (LCG) with a rolling seed value. The processor 104 is configured to use the LCG to ensure complete coverage of all data blocks/offsets within the backup data across a predetermined number of backup cycles. In this embodiment, the LCG is configured to generate a series of values to select data blocks or offsets for the subset. The LCG is employed to maintain a uniform distribution of data block selection. In another embodiment, the processor 104 may employ alternative randomization techniques to achieve substantial uniformity in block selection while avoiding repetition or overlap during verification.

The pseudo-random generator 108 is configured to identify the subset such that each offset for a backup data is verified at least once in a pre-determined number of cycles. Moreover, each offset is verified at least once a day across all customers of the system. The offsets are selected such that they are agnostic of changed data. In addition, the integrity code employed by the system is different than the existing backup code of the system.

The processor 104 is further configured to compare the checksums of one or more data blocks of the files of the identified subset with the checksums of corresponding source data blocks via the checksum comparator 110. The checksum comparison facilitates detection of data corruption within the backup storage system 114. The processor 104 is configured to perform integrity checks independently of any data modifications since the previous backup to ensure continuous system reliability.

Additionally, the processor 104 is configured to compute the checksum of the data blocks/offsets in the identified subset using a cryptographic hash function. The processor 104 is further configured to investigate byte-for-byte equality between the data blocks of the source 112 and the backup storage system 114 for the selected subset once a backup operation is completed.

In this example, the system is configured to identify a plurality of data corruption issues such as issues with local state codes, identification of changed blocks across backups, bugs or unknown limitations in applications change tracking APIs, missed additions/deletions/modifications of files and blocks due to incorrect usage of change tracking APIs and any issues resulting from concurrency, or bugs in data transfer pipelines.

The processor 104 is further configured to generate or update an integrity check log 120 upon detecting data corruption. The integrity check log 120 may be present to a user of the system 100 via output 118. The integrity check log 120 incudes detailed information of the corrupted data blocks or files to provide a comprehensive record of the issues detected during the integrity check. The integrity check log 120 is configured to ensure that any discrepancies or corruption in the backup data are documented and can be tracked for resolution.

In another embodiment, the integrity check log 120 is presented to a user of the system 100 and help them to take appropriate actions based on the detected data corruption information. The user may initiate data recovery processes or employ manual intervention measures to address the data corruption to ensure minimal data loss and quick restoration of system integrity.

The processor 104 is further configured to reset the selection of backup cycle upon detection of the cumulative size of the verified files being equal to the total size of the backup dataset. The system 100 is configured to ensure that the entire backup dataset is covered during verification to provide comprehensive and complete coverage of the backup data for integrity checks.

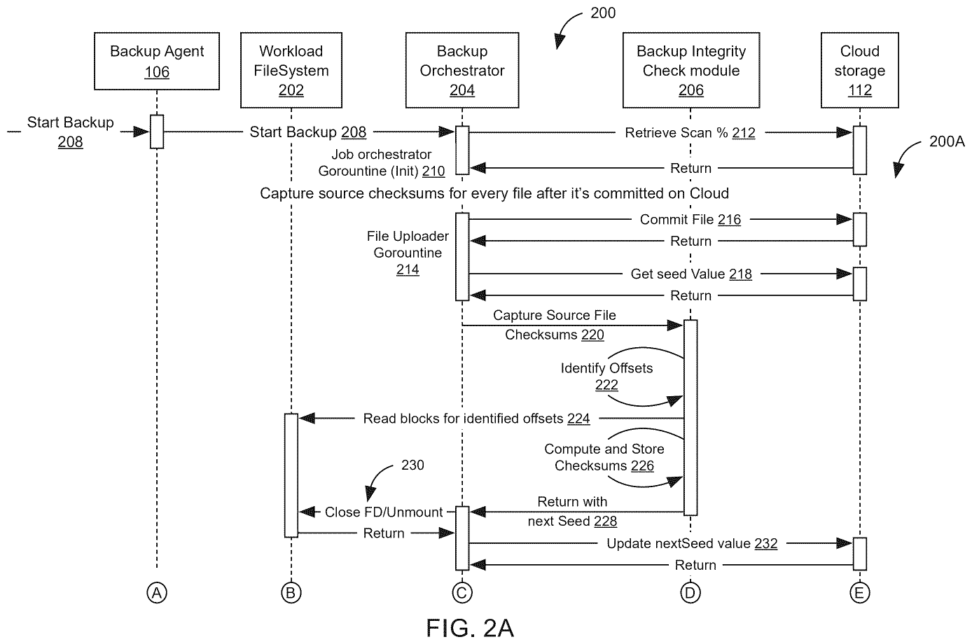

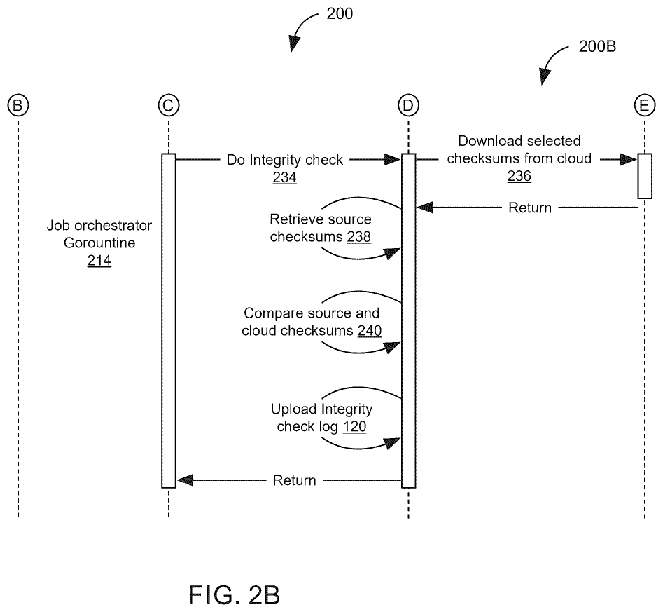

The system 100 described above is configured to support storage solutions that include local storage, network-attached storage (NAS), and cloud-based storage solutions, or combinations thereof. This flexibility allows the system 100 to adapt to varying backup infrastructure, ensuring compatibility with a wide range of storage environments, whether on-premises or in the cloud. The detailed workflow of the system 100 is described with reference to FIG. 2.

FIGS. 2A and 2B illustrate example workflow 200 of detecting data corruption using the system 100 of FIG. 1. As illustrated, the system 100 includes the backup agent 106, a workload file system 202, a backup orchestrator 204, a backup integrity check module 206, that communicate with the cloud storage 112.

The backup agent 106 is configured to initiate a backup process 208 by interfacing with the workload file system 202 to read data blocks that are required to be backed up. The backup agent 106 is configured to prepare data for subsequent stages to ensure that the data is formatted, structured, and is ready for efficient transfer to downstream components of the system.

Once the backup agent 106 completes the initial data preparation, the backup orchestrator 204 implements a job orchestrator goroutine 210. The backup orchestrator 204 is configured to coordinate the process and manage interactions between modules of the system. The backup orchestrator 204 is configured to capture a retrieved scan % 212 periodically to track the completion status of the backup process. The retrieved scan % 212 indicates the proportion of data blocks successfully processed at any given stage.

Data then passes through the backup integrity check module 206, that validates the data blocks, and proceeds to cloud storage 112 for secure storage. At this stage, the system 100 captures source checksums for every file after it is committed to cloud storage 112 to ensure integrity.

The backup orchestrator 204 is configured to implement a file uploader goroutine 214, that commits individual files 216 to the cloud storage 112. The file uploader goroutine 214 is configured to retrieve a seed value 218, update it to reflect the progress the backup process, and return the updated seed value to the backup orchestrator 204. Again, the backup orchestrator 204 is configured to capture source file checksums 220 and forward them to the backup integrity check module 206 for further validation.

The backup integrity check module 206 identifies one or more offsets 222 in the data blocks and reads the corresponding data blocks 224 from the workload file system 202. The backup integrity check module 206 is configured to compute and store checksums 226 for these blocks to ensure their accuracy and consistency. In this example, the foregoing steps are followed in a repetitive cycle, with new seed values 228 being updated and returned, until all data blocks have been processed. The workflow also includes closing file descriptors (FD) and unmounting resources 230 as necessary. The backup orchestrator further updates next seed value to the cloud storage 232.

The following steps are illustrated in 200B, where the job orchestrator goroutine 210 initiates a comprehensive integrity check 234. The backup integrity check module 206 downloads selected checksums 236 from the cloud storage 112 and retrieve source checksums 238. The backup integrity check module 206 compares source and cloud checksums 238. This ensures that the data stored in the cloud storage 112 matches the original data from the workload file system 202. Any discrepancies are documented, and an integrity check log 120 is uploaded to the cloud storage 112. Further, the backup integrity check module 206 returns control to the backup orchestrator 204.

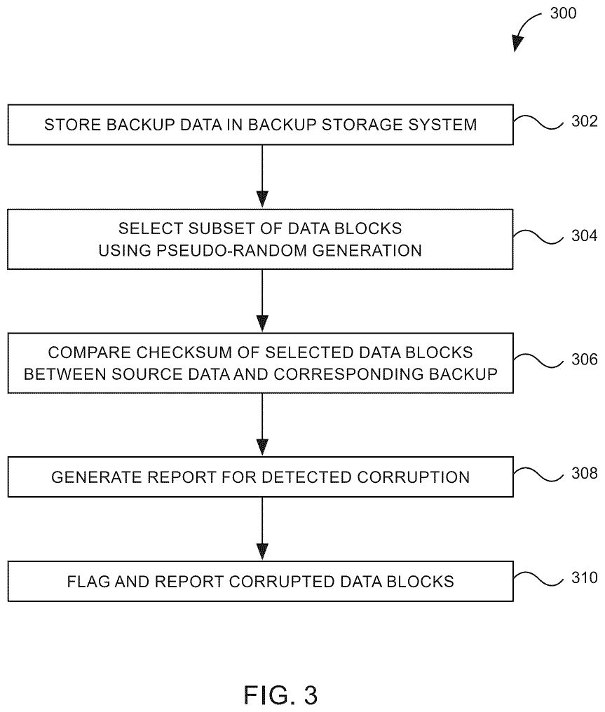

FIG. 3 is a flowchart 300 illustrating the process of detecting data corruption using the system 100 of FIG. 1. At block 302, backup data from multiple customer sources are stored in a backup storage system. The backup data includes block-level data snapshots, that may provide a detailed and granular view of the backup dataset.

At block 304, a subset of data blocks from the backup dataset is selected using a pseudo-random generator. In one example, the pseudo-random generator is a Linear Congruential Generator (LCG) that is configured to generate a rolling seed value. The selected subset includes data block offsets to ensure coverage of all data blocks within a pre-determined number of backup cycles to facilitate a comprehensive integrity check across the entire dataset.

The checksum of the selected data blocks is compared between the source data and the corresponding backup data (block 306) and any discrepancies or corruption between the source and backup data are detected by verifying the checksums. The process involves generating unique identifiers, or checksums, for each data block using different algorithms.

At block 308, a report is generated that details any detected data corruption or integrity failures within the verified data blocks. Such corrupted data blocks are flagged and reported for further investigation or recovery to ensure that timely actions are taken to address the identified issues (block 310).

The process is repeated across multiple backup cycles to ensure that all data blocks and files are verified at least once. This continuous verification helps to maintain the integrity of the backup system over time to ensure that any corrupted data is promptly identified and corrected.

In one embodiment, the method further includes initiating data recovery and/or employing manual intervention measures based on the detected data corruption information. This allows users to take immediate action to recover corrupted data or manually intervene to mitigate further issues.

Additionally, the system is configured to perform the integrity check for the selected datasets immediately after the completion of a backup operation. This ensures that any potential issues are identified and addressed without delay, maintaining the reliability and integrity of the backup data.

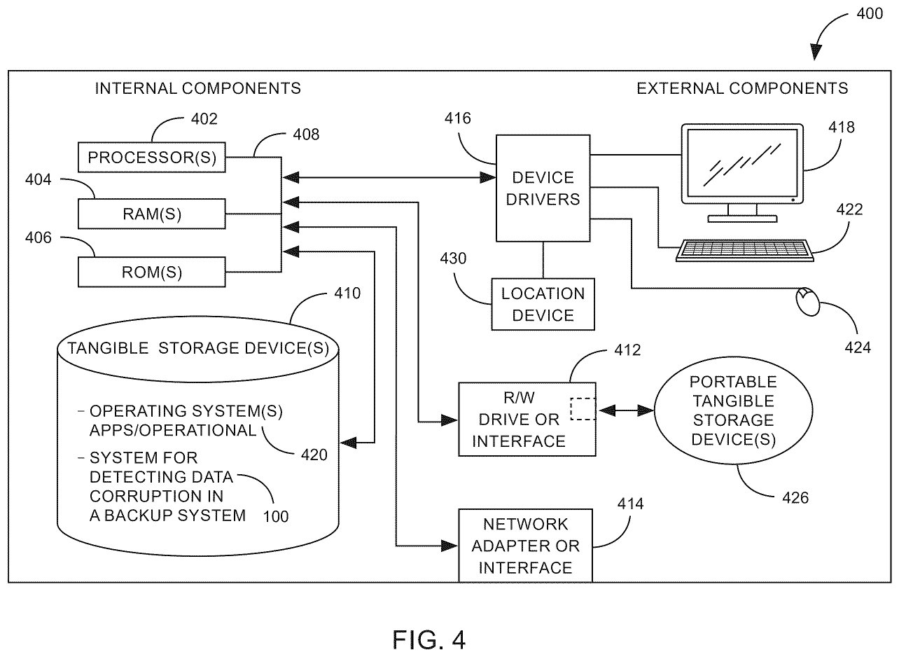

The modules of the system 100 for detecting data corruption in a backup system, described herein, are implemented in computing devices to facilitate user assistance and task execution. One example of a computing device 400 is described below in FIG. 4. The computing device 400 includes one or more processor(s) 402, one or more computer-readable RAMs 404, and one or more computer-readable ROMs 406 on one or more buses 408. Further, the computing device 400 includes a tangible storage device 410 that may be used to execute operating systems 420 and the system 100 for detecting data corruption in a backup system. The various modules of the system 100 for detecting data corruption in a backup system may be stored in the tangible storage device 410. Both, the operating systems 420 and the system 100 for detecting data corruption in a backup system are executed by one or more processor(s) 402 via one or more respective RAMs 404 (which typically include cache memory). The execution of the operating systems 420 and/or the system 100 for detecting data corruption in a backup system by the one or more processor(s) 402, configures the one or more processor(s) 402 as a special purpose processor configured to carry out the functionalities of the operation systems 420 and/or the system 100 for detecting data corruption in a backup system as described above.

Examples of tangible storage devices 410 include semiconductor storage devices such as ROM, EPROM, flash memory, or any other computer-readable tangible storage device that may store a computer program and digital information.

The computing device 400 also includes an R/W drive or interface 414 to read from and write to one or more portable computer-readable tangible storage devices 428 such as a CD-ROM, DVD, memory stick, or semiconductor storage device. Further, network adapters or interfaces 412 such as TCP/IP adapter cards, wireless Wi-Fi interface cards, or 3G or 4G wireless interface cards, or other wired or wireless communication links are also included in computing devices.

In one example embodiment, the system 100 for detecting data corruption in a backup system may be stored in the tangible storage device 410 and may be downloaded from an external computer via a network (for example, the Internet, a local area network, or other, wide area network) and network adapter or interface 412.

Computing device 400 further includes device drivers 416 to interface with input and output devices. The input and output devices may include a computer display monitor 418, a keyboard 422, a keypad, a touch screen, a computer mouse 424, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A system for detecting data corruption in a backup system, wherein the system comprises:
a memory storing one or more processable routines; and
a processor communicatively coupled to the memory, the processor configured to execute the one or more processor-executable routines to:
access backup data with a plurality of backup datasets stored in a backup storage system, wherein the backup datasets comprise block-level data snapshots of data files for one or more customers stored on a source;
identify a subset of the backup data across a plurality of backup cycles using a pseudo-random generator;
compare checksums of one or more data blocks of the files of the identified subset with checksums of corresponding source data blocks to detect data corruption in the backup system; and
generate or update an integrity check log with the detected data corruption information.

2. The system of claim 1, wherein the processor is configured to identify the subset such that each data block/offset of the subset is verified at least once within a predetermined number of backup cycles.

3. The system of claim 2, wherein offset ranges correspond to data of a plurality of backup sources and wherein the processor is configured to identify the subset such that each offset range across the multiple backup sources is verified at least once over a pre-determined period of time.

4. The system of claim 1, wherein the pseudo-random generator comprises a Linear Congruential Generator (LCG) having a rolling seed value to facilitate coverage of all offsets in the subset across the pre-determined number of backup cycles.

5. The system of claim 4, wherein the pseudo-random generator is configured to generate a series of values to select data block/offsets for the subset.

6. The system of claim 1, wherein the pseudo-random generator comprises random number generator having a substantial uniformity.

7. The system of claim 1, wherein the processor is configured to perform integrity checks of the backup system independently of data modification since a previous backup.

8. The system of claim 1, wherein the processor is configured to compute the checksum of the data blocks of the identified subset using a hash function.

9. The system of claim 1, wherein the processor is configured to investigate byte-for-byte equality between the data blocks of the source and the backup storage system for the selected subset.

10. The system of claim 1, wherein the processor is configured to perform the integrity check for the selected subset immediately post a backup operation is completed.

11. The system of claim 1, wherein the integrity check log is presented to a user of the system to initiate data recovery or employ manual intervention measures based upon detected data corruption information.

12. The system of claim 1, wherein the processor is configured to reset the selection cycle upon detection of the cumulative size of the verified files being equal to the total size of the backup dataset to provide complete coverage of backup datasets for verification.

13. The system of claim 1, wherein the system is configured to support local, network-attached storage (NAS), and cloud-based storage solutions, or combinations thereof.

14. A system for detecting data corruption in a large-scale backup environment, wherein the system comprises:
a memory storing one or more processor-executable routines; and
a processor communicatively coupled to the memory, the processor configured to execute the one or more processor-executable routines to:
initiate a backup operation of plurality of backup datasets between a backup storage system and cloud storage, wherein the backup sets comprise block-level data snapshots;
capture checksums of source data blocks during the backup process;
identify data block offsets for integrity verification using a predetermined method;
read the data blocks at the identified offsets from both the source and the backup storage system;
compare the checksums of the identified data blocks; and
report any discrepancies detected in the checksums and flag corrupted data blocks for further investigation or recovery.

15. The system of claim 14, wherein the processor is further configured to use a pseudo-random generator to identify the data block offsets to ensure coverage of all data blocks within a predetermined number of backup cycles.

16. The system of claim 14, wherein the processor is configured to perform the checksum comparison using a cryptographic hash function.

17. A method for detecting data corruption in a large-scale backup environment, wherein the method comprises:
storing backup data from multiple customer sources in a backup storage system, wherein the backup data comprises block-level data snapshots;
selecting a subset of data blocks from the backup dataset using a pseudo-random generator;
comparing the checksum of the selected data blocks between the source data and the corresponding backup;
generating a report detailing any detected data corruption or integrity failures within the verified data blocks;
flagging and reporting the corrupted data blocks for further investigation or recovery; and
repeating the process across multiple backup cycles to ensure that all data blocks and files are verified at least once.

18. The method of claim 17, wherein the pseudo-random generator comprises a Linear Congruential Generator (LCG) configured to generate a rolling seed value to facilitate coverage of all offsets in the subset across the pre-determined number of backup cycles.

19. The method of claim 17, further comprising initiating data recovery and/or employing manual intervention measures based upon detected data corruption information.

20. The method of claim 17, wherein the method is configured to perform the integrity check for the selected datasets immediately post a backup operation is completed.
